(19) United States
(12) Patent Application Publication
(10) Pub. No.: US 2015/0287038 A1
(43) Pub. Date: Oct. 8, 2015

(54) DATA VISUALIZATION USING DISPLACEMENT SHAPES

(71) Applicant: Oracle International Corporation, Redwood Shores, CA (US)

(72) Inventors: Brent-Kaan William White, San Francisco, CA (US); Eduardo Lopez Grijalva, Jalisco (MX); Fernando Jimenez Lopez, Jalisco (MX); Laurie Pattison, Reno, NV (US); Antonio Aguilar, Jalisco (MX)

(21) Appl. No.: 14/476,962

(22) Filed: Sep. 4, 2014

Related U.S. Application Data
(60) Provisional application No. 61/975,633, filed on Apr. 4, 2014.

(51) Int. Cl. G06Q 30/00; G06Q 10/04; G06F 3/0484; G06F 3/0486; G06T 11/20; G06F 3/0481

(52) U.S. Cl. CPC G06Q 30/01; G06T 11/206; G06F 3/04817; G06F 3/04842; G06F 3/0486; G06Q 10/04; G06T 2200/24

(57) ABSTRACT

Data visualizations include first and optionally second containers representing first and second time periods, respectively; each container encloses icons representing data entities associated with the container's time period. Icons from the first and second containers may be moved to the other container to change the time periods associated with data entities corresponding to the moved icons. Additionally, changes to attributes of data entities made via the data visualization may be shared with other users. A level indicator representing data entities associated with the first container aggregate attribute value changes in response to icons being added to or removed from the first container. The containers may be visually styled as cups, the level indicators as liquid and/or a straw contained in the cup, and the icons as bubbles or other objects in the liquid.

### CROSS REFERENCES TO RELATED APPLICATIONS

This application claims priority from U.S. Provisional Patent Application Ser. No. 61/975,633, entitled DATA VISUALIZATION USING DISPLACEMENT SHAPES, filed on Apr. 4, 2014, which is hereby incorporated by reference as if set forth in full in this application for all purposes.

### BACKGROUND

This application relates to the field of user interfaces for visualizing and forecasting deal and other enterprise data. Customer Relation Management (CRM) applications are intended to organize and automate interactions between an organization's representatives, such as salespeople, and the organization's customers and potential customers. CRM applications can assist organizations with managing interactions with customers and potential customers in a number of different ways.

Monitoring the activity of salespeople on deal opportunities is one task typically performed by CRM applications. Deal managers may view the data collected by CRM applications to monitor the activities of their salespeople. One task for managers is to ensure that their sales organizations meet their near-term and long-term targets. To do this, it is important for managers to be able to identify whether they are on track to meet their performance targets. Additionally, if managers are facing potential shortfalls in their sales goals, it is important for managers to be able to identify any deal opportunities in progress that could be given additional resources to accelerate deal completion and meet their targets.

Unfortunately, current CRM applications do not make it easy for deal managers to view the totality of deal opportunities in progress, to identify potential shortfalls, and to identify potential deal opportunities that could be used to make up any shortfalls. Current CRM applications often present deal opportunity data in a tabular format and require deal managers to sort and manually analyze columns of data to understand the overall status of the deal opportunities in progress. Additionally, current CRM applications do not make it easy for managers to explore hypothetical situations for meeting performance targets.

### SUMMARY

Embodiments of the invention include data visualizations including a first container representing a first time period. An interior region of the first container is adapted to at least partially enclose icons representing data entities associated with the first time period. A level indicator representing an aggregate value of the data entities associated with the first time period is adapted to change in response to icons being added to or removed from the first container in accordance with the size of the first icon. Embodiments of the invention may size icons according to attribute values of their corresponding data entities.

In a further embodiment, the data visualization also includes a second container representing a second time period. The second container includes a second interior region adapted to at least partially enclose additional icons representing second data entities associated with the second time period. Icons from the first and second containers may be moved to the other container to change the time periods associated with data entities corresponding with the moved icons. Additionally, changes to attributes of data entities made via the data visualization may be shared with other users.

Implementations of embodiments of the invention may visually style containers as cups, the level indicators as liquid contained in the cup, and the icons as bubbles or other objects in the liquid. Still further implementations of embodiments of the invention may visually style the level indicator as a straw in the cup, with the angle of the straw indicating progress towards a desired aggregate attribute value.

Still further embodiments of the invention may include gradations and/or time scales in one or more of the containers. In these embodiments, attributes of the data entities may be used to position icons in the container with respect to these gradations and/or time scales. Yet additional embodiments may shade, color, and/or pattern icons based on other data entity attributes.

Embodiments of the invention are applicable to any type of data entity and applications. One example application of embodiments of the invention is a sales forecast visualization of deal information in a CRM application.

A further understanding of the nature and the advantages of particular embodiments disclosed herein may be realized by reference of the remaining portions of the specification and the attached drawings.

### BRIEF DESCRIPTION OF THE DRAWINGS

The invention will be described with reference to the drawings, in which:

FIG. 1 illustrates an example sales forecast visualization according to an embodiment of the invention;

FIGS. 2A-2B illustrate a first example interaction with a sales forecast visualization according to an embodiment of the invention;

FIGS. 3A-3B illustrate a second example interaction with a sales forecast visualization according to an embodiment of the invention;

FIG. 4 illustrates a method for generating a sales forecast visualization in response to user interactions according to an embodiment of the invention;

FIG. 5 illustrates an example sales forecast visualization according to another embodiment of the invention;

FIG. 6 illustrates a third example interaction with a sales forecast visualization according to an embodiment of the invention;

FIG. 7 illustrates an example sales forecast visualization according to yet another embodiment of the invention;

FIG. 8 illustrates a fourth example interaction with a sales forecast visualization according to an embodiment of the invention;

FIGS. 9A-9B illustrate example collaboration interfaces and functions suitable for use with embodiments of the invention; and

FIG. 10 illustrates an example system suitable for implementing embodiments of the invention.

### DETAILED DESCRIPTION OF EMBODIMENTS

Embodiments of the invention include data visualizations and user interfaces adapted to help deal managers determine whether they are on track to meet their performance targets, identify specific deal opportunities that could be used to make up any shortfalls, explore hypothetical situations for meeting performance targets, and sharing proposed changes and/or instructions with regard to deal opportunities with additional users. Although the below descriptions of visualizations and interactions are discussed in the context of sales information in a CRM application, embodiments of the invention are applicable to any other type of data and applications.

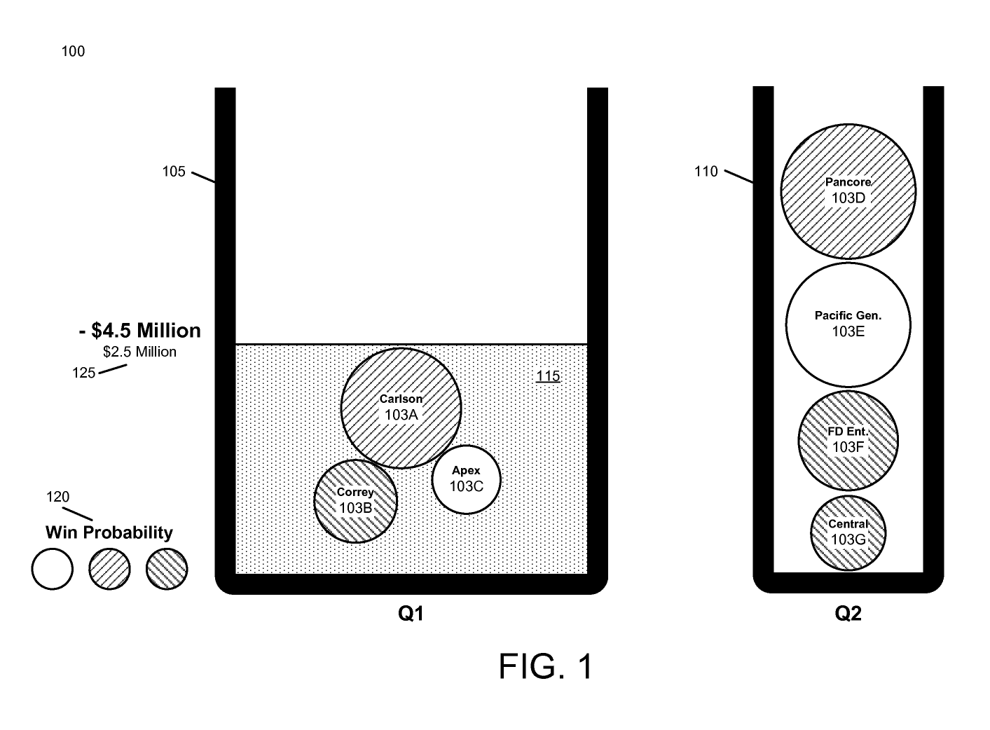

FIG. 1 illustrates an example sales forecast visualization 100 according to an embodiment of the invention. Visualization 100 includes at least two containers 105 and 100. Container 105 represents sales information for a present time period, such as the current fiscal quarter, month, year, or other time period of interest. Container 110 represents a future time period 110, such as a subsequent fiscal quarter, month, year, or other future time period of interest. In this example, container 105 is associated with a hypothetical quarter 1 (Q1) and container 110 is associated with a hypothetical quarter 2 (Q2).

Each of the containers 105 and 110 may optionally contain deal icons 103, with each of the deal icons 103 representing a specific business deal or other transaction. Locating a deal icon in a container indicates that the corresponding deal is expected to be closed in the time period associated with the container. For example, container 105 includes deal icons 103A, 103B, and 103C, indicating that these deals are expected to close in Q1, and container 110 includes deal icons 103D, 103E, 103F, and 103G, indicating that these deals are expected to close in Q2. Each of the containers may include zero or any arbitrary number of deal icons.

A further embodiment sizes deal icons 103 in proportion to their absolute or relative value, for example with more valuable deals represented by larger deal icons. In example visualization 100, deal icons 103A, 103D, and 103E are larger than deal icons 103B, 103C, 103F, and 103G, indicating that each of the former group of deals are more valuable than the deals in the latter group.

Yet a further embodiment shades, colors, or otherwise patterns deal icons 103 to indicate additional information, such as the win probability, or probability of completing the deal; the amount of recent activity associated with the deal; the amount of time that the deal have been in progress, in total or within a specific sales stage or category; a product, service, or region category associated with a deal; a business group, division, or individual responsible for the deal; or any other attribute associated with the deal. Still a further embodiment displays a legend 120 to assist users in understanding the shading, coloring, or other patterning of deal icons 103.

An additional embodiment optionally displays text labels on some or all of the deal icons. Text labels may include information such as the deal name, customer name, win probability, deal value, or any other attributes associated with the deal. Text labels may be omitted or abbreviated for some of the deal icons 103, such as for smaller deal icons. Additionally, a pop-up window may display deal attributes in response to user interaction with a deal icon, such as selecting or moving the deal icon, and disappear when the user interaction is complete.

Yet an additional embodiment of the invention displays an aggregate value indicator 115 in container 105 and/or container 110. Aggregate value indicator 115 may be displayed in the form of a liquid filling the container 105, with the height of the liquid proportional to an aggregate value of deal attributes associated with the time period represented by the container. For example, aggregate value indicator 115 may represent the total value of the deals having deal icons in container 105. In still an additional embodiment, an aggregate value indicator label 125 may provide text and/or numerical labels related to the aggregate value indicator 115. For example, aggregate value indicator label 125 specifies that the total value of the deals associated with container 105 is $2.5 million and this value is short of a goal value by $4.5 million.

Visualization 100 may arrange deal icons 103 in containers 105 and 110 in numerous ways. For example, deal icons 103A-C in container 105 are arranged in a cluster formation. Deal icons 103D-G in container 110 are arranged in a sorted arrangement, with the larger valued deal icons at higher levels than smaller valued deal icons. As described in detail below, as deal icons are added or removed from container 110, the arrangement of deal icons is automatically updated to maintain the sorting by deal value.

In still another embodiment, container 110 may show only a portion of the deal icons representing pending deals in the associated time period, such as the highest valued deals. Other deals outside of this portion, such as deals with lower values, may have corresponding deal icons located off-screen. In this embodiment, a user may optionally vertically or horizontally scroll the deal icons in container 110 to reveal the hidden deal icons. For example, if the deal icons in container 110 are arranged in order of deal value, vertically scrolling in the container 110 may reveal additional lower-valued deal icons rising from the bottom of the container 110.

In still a further embodiment, users and applications may apply filtering criteria to limit the display of deal icons and aggregate indicators in the sales forecast visualization 100. Filtering criteria may include any attribute associated with a deal or other entity in the CRM software, including all or part of a deal or customer name; a deal value; the deal win probability; the amount of recent activity associated with the deal; a sales stage or other deal progress metric or category; the amount of time that the deal have been in progress, in total or within a specific sales stage or category; a product, service, or region category associated with a deal; and a business group, division, or individual responsible for the deal.

Embodiments of the sales forecast visualization 100 may visually model the containers as cups, the aggregate value indicator as a liquid level in a cup, and the deal icons as bubbles or objects in the liquid.

Sales forecast visualization 100 presents sales forecast information to users. Additionally, embodiments of the invention allow users to explore hypothetical changes in the sales forecast information by modifying the locations of deal icons in the sales forecast visualization 100.

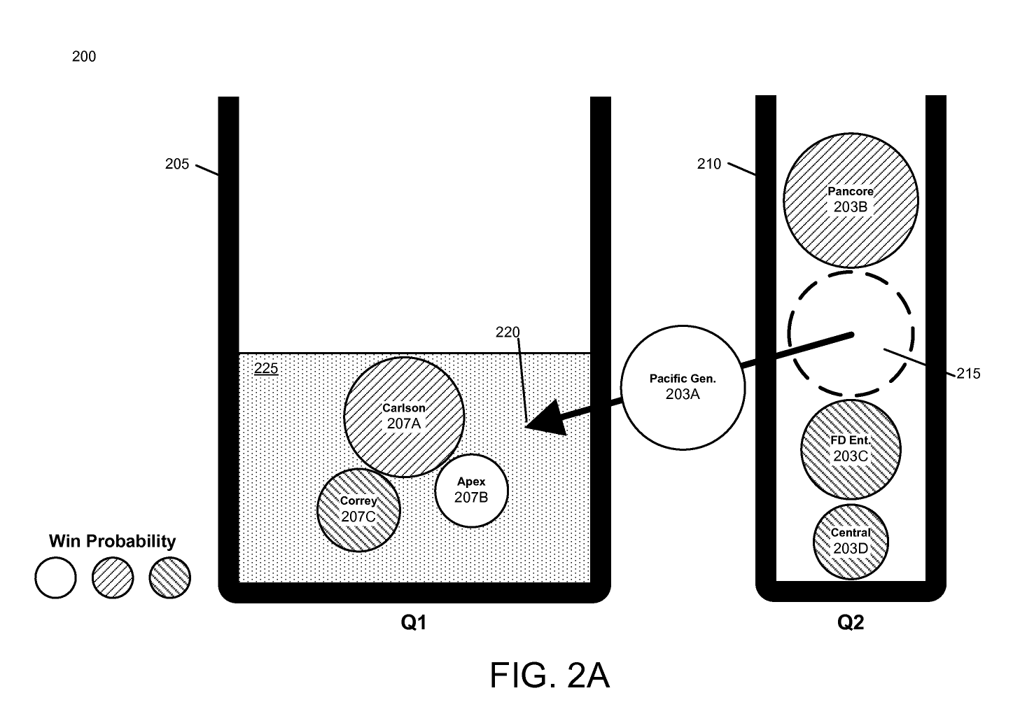

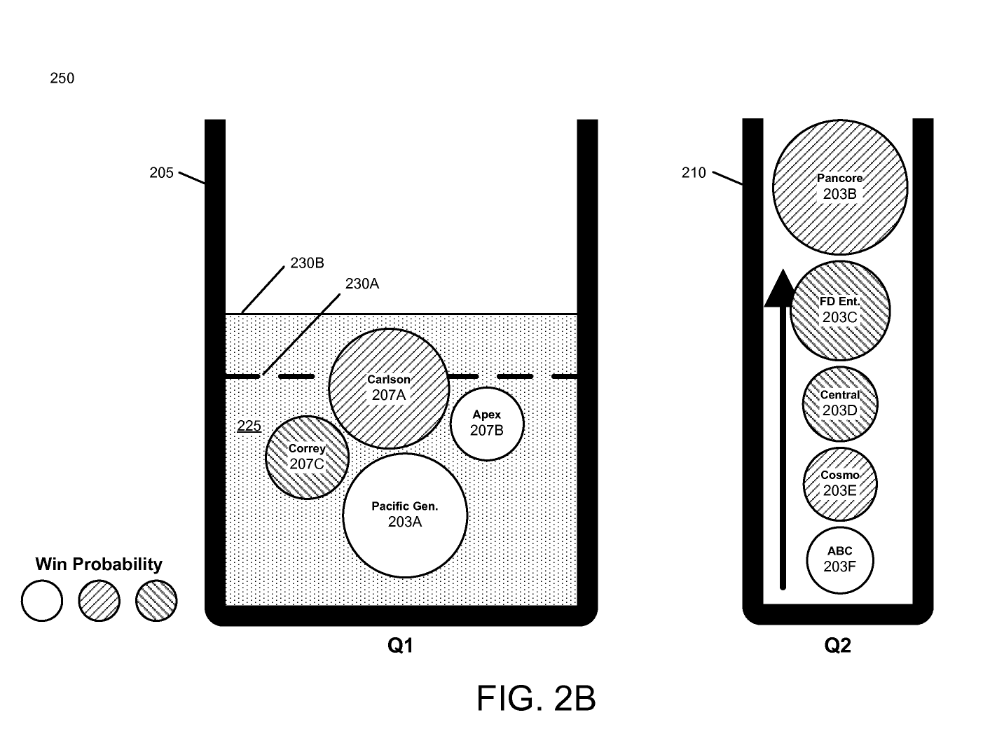

FIGS. 2A-2B illustrate a first example interaction with a sales forecast visualization according to an embodiment of the invention. This first example interaction shows the effect of moving a deal closing date from a future time period to the present time period. FIG. 2A illustrates an example sales forecast visualization 200 similar to visualization 100, including containers 205 and 210, containing deal icons 207A-C and 203B-D, respectively. Container 205 also includes an aggregate value indicator 225 representing the aggregate value of an attribute, such as the deal value, of deal icons 207A-C.

In example 200, a user interaction, such as a mouse, keyboard, touchscreen or touchpad, voice, or gesture input, selects deal icon 203A and moves it from a starting location 215 in container 210 to an ending location 220 anywhere within the container 205. During this user interaction, further embodiments of the invention may optionally display text and/or graphics labels of deal attributes associated with the deal icon, for example the complete deal name, deal value, and/or deal win probability.

FIG. 2B illustrates an example sales forecast visualization 250 following the completion of the user interaction shown in FIG. 2A. After the user interaction, deal icon 203A is located in container 205. Deal icon 203A and deal icons 207A-C may be rearranged within container 205 according to the visual arrangement scheme used by container 205, such as clustering and/or moving larger deal icons towards the top.

Because deal icon 203A is now located in container 205 instead of container 210, the aggregate value indicator 225 increases from level 230A to 230B, representing the additional value associated with deal icon 203A. The increase of the aggregate value indicator 225 may be proportional or generally related to the deal value of the added deal icon 203A.

Because deal icon 203A has been removed from container 210, the deal icons remaining in container 210 may be rearranged. In an embodiment, deal icons 203B and 203C rise up to fill the void left by deal icon 203A. Additional deal icons 203E and 203F scroll onscreen from the bottom of container 210 into view.

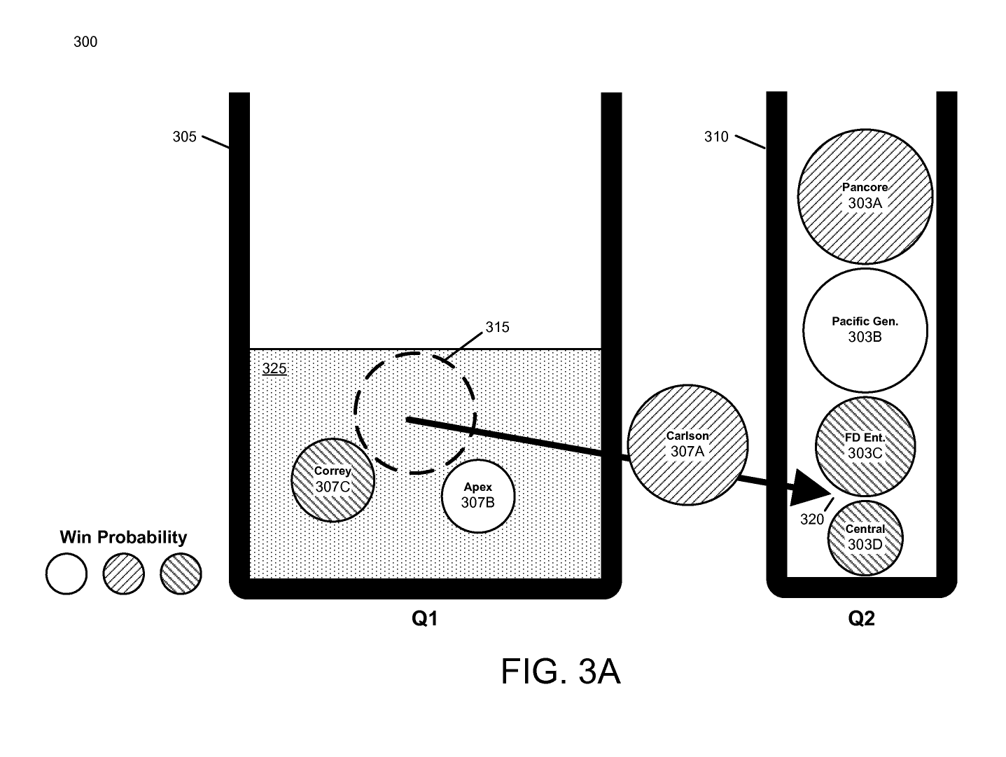

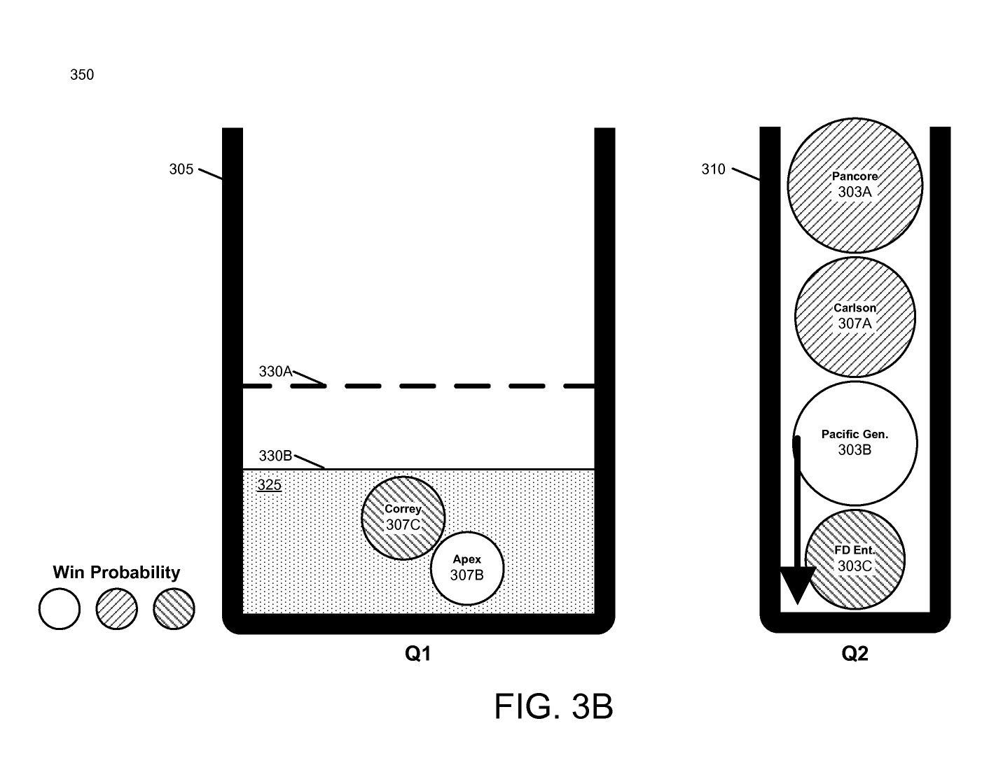

FIGS. 3A-3B illustrate a first example interaction with a sales forecast visualization according to an embodiment of the invention. This second example interaction shows the effect of moving a deal closing date from the present time period to a future time period. FIG. 3A illustrates an example sales forecast visualization 300 similar to visualization 100, including containers 305 and 310, containing deal icons 307B-C and 303A-D, respectively. Container 305 also includes an aggregate value indicator 325 representing the aggregate value of an attribute, such as the deal value, of deal icons 307A-C.

In example 300, a user interaction, such as a mouse, keyboard, touchscreen or touchpad, voice, or gesture input, selects deal icon 307A and moves it from a starting location 315 in container 305 to an ending location 320 anywhere within the container 310. During this user interaction, further embodiments of the invention may optionally display text and/or graphics labels of deal attributes associated with the deal icon, for example the complete deal name, deal value, and/or deal win probability.

FIG. 3B illustrates an example sales forecast visualization 350 following the completion of the user interaction shown in FIG. 3A. After the user interaction, deal icon 307A is located in container 310. In an embodiment, deal icon 307A is positioned in container 310 according to its deal value relative to the other deal icons. For example, deal icon 307A is positioned between deal icons 303A and 303B. An embodiment accomplishes this arrangement by moving deal icon 303D downward and off-screen and deal icons 303B and 303C downward to make space for deal icon 307A.

Because deal icon 307A is now located in container 310 instead of container 305, the aggregate value indicator 325 decreases from level 330A to 330B, representing the loss of value associated with deal icon 307A. This decrease may be proportional or generally related to the deal value associated with deal icon 307A. Similarly, the remaining deal icons in container 305 may rearrange themselves according to the visual arrangement scheme, such as clustering and/or moving larger deal icons towards the top.

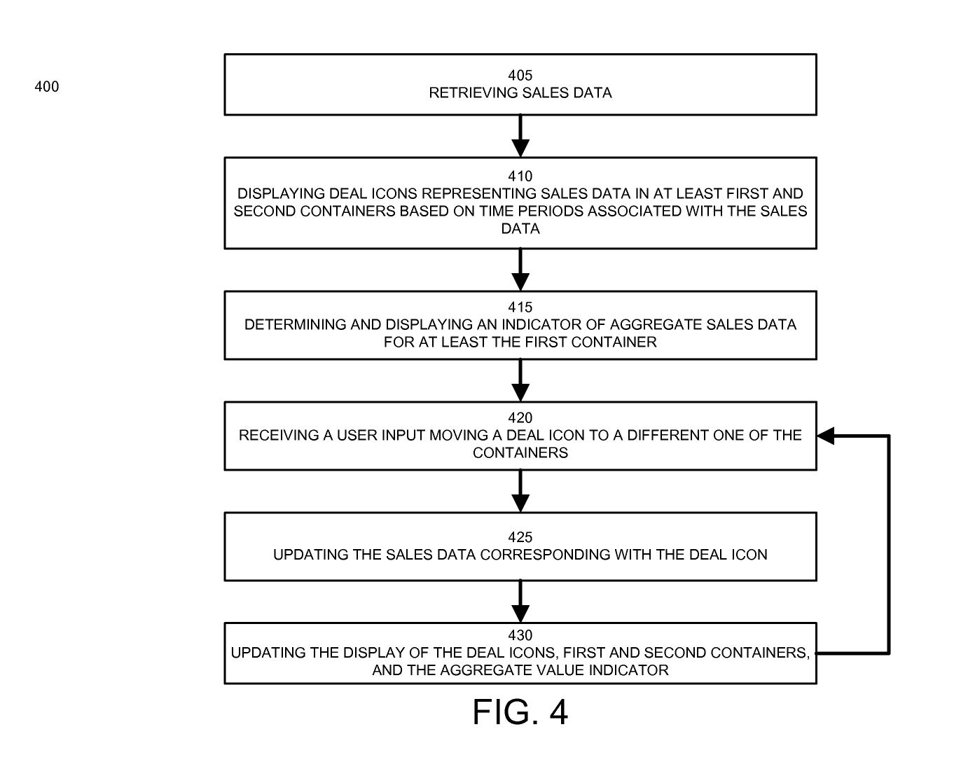

FIG. 4 illustrates a method 400 for generating a sales forecast visualization in response to user interactions according to an embodiment of the invention. Method 400 begins with step 405 retrieving sales data for display. In an embodiment step 405 retrieves sale data for deals pending and expected to close in each time period associated with a container to be displayed, such as the current fiscal quarter or other current time period and the next fiscal quarter or other subsequent time period. As described above, user- or application-defined filtering criteria may be applied to further limit the sales data retrieved based on any deal attributes, including all or part of a deal or customer name; a deal value; the deal win probability; the amount of recent activity associated with the deal; a sales stage or other deal progress metric or category; the amount of time that the deal have been in progress, in total or within a specific sales stage or category; a product, service, or region category associated with a deal; and a business group, division, or individual responsible for the deal.

Step 410 displays deal icons representing the retrieved sales data in at least first and second containers based on the time periods associated with the sales data. As discussed above, the size and coloring or shading of each deal icon may be used to convey additional information, such as the value of the deal and/or other deal attributes. Further embodiments of the invention may use any other visual aspects of the deal icons, such as text labels and icon shape, to convey information about deal attributes to users.

Step 415 determines an aggregate deal attribute value for the deal icons associated with at least one of the time periods of interest and displays an aggregate value indicator in each container based on the determined aggregate value. For example, step 415 may access deal attributes for each of the deals in the present time period (possibly limited by any filtering criteria), to determine the value of each deal and then sum these values to get an aggregate deal value. In a further example, step 415 may compare this aggregate deal value with a goal or quota value for the time period to determine if pending deals are above, below, or at their goal value. Step 415 then generates and displays an aggregate value indicator and optionally aggregate value indicator label to present this information to users.

As described above, the sales forecast visualization may be modified in response to user interactions to explore hypothetical changes to the sales forecast. Additionally, these hypothetical changes may be saved to update the sales forecast and, as described below, shared with other users. When a user initiates a user interaction with the sales forecast visualization, step 420 receives a user input moving a deal icon from its current container to a different container.

Step 425 updates sales data corresponding with the moved deal icon. For example, if the deal icon is moved from a container representing the present time period to a container representing a future time period, then step 425 modifies the deal closing date attribute of the sales data associated with this deal icon accordingly. In further embodiments, moving deal icons may change other attributes of the sales data associated with a deal icon, such as the sales stage, in a similar manner.

After step 425 updates the sales data based on the movement of the deal icon, step 430 updates the sales forecast visualization to display deal icons in their new container locations and a new aggregate value indicator. Embodiments of step 430 may reposition deal icons within their containers according to visual arrangement and/or sorting schemes. For example, step 430 may distribute deal icons according to a cluster visual arrangement scheme, as shown in example container 105, or sort deal icons according to a deal attribute value, such as the deal value, as shown in example container 110.

Method 400 optionally may repeat steps 420 to 430 to update the sales data and sales forecast visualization for any additional user interactions.

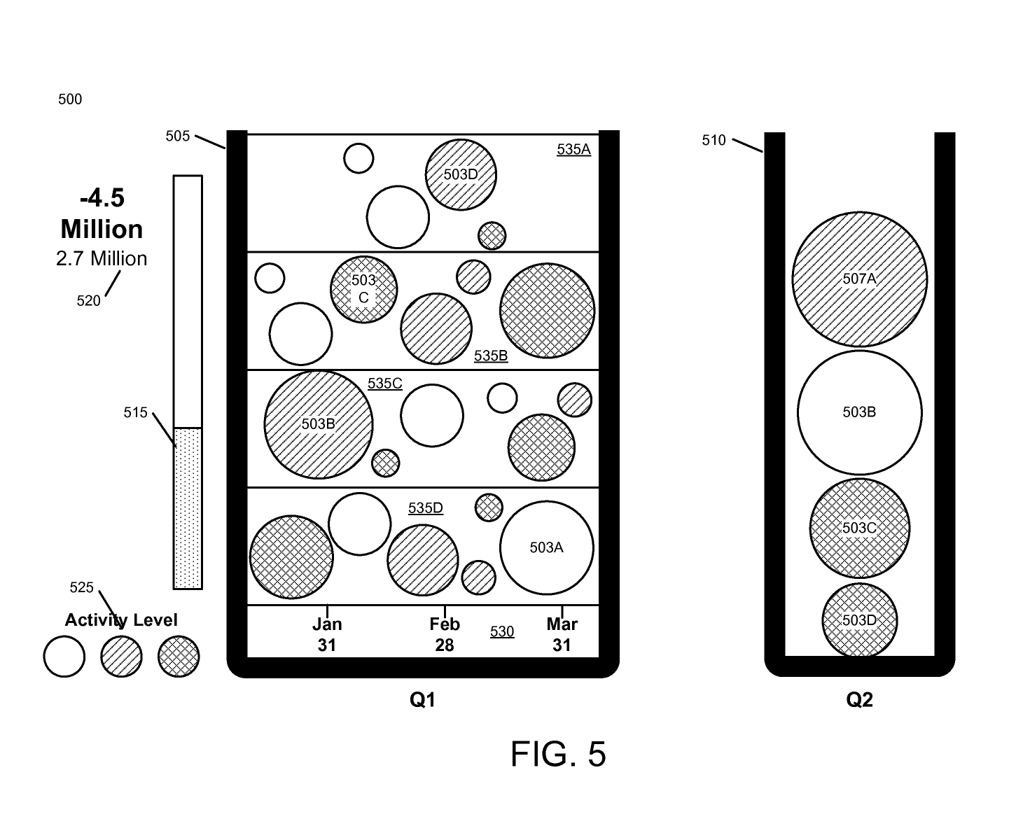

FIG. 5 illustrates an example sales forecast visualization 500 according to another embodiment of the invention. Visualization 500 is similar to visualization 100 and includes at least two containers 505 and 510, representing sales information for a present time period (Q1) and a future time period (Q2), respectively. Containers 505 and 510 optionally contain deal icons, including deal icons 503A-503D in container 505 and 507A-D in container 510. Each of the containers 505 and 510 may include zero or any arbitrary number of deal icons. Additional embodiments may allow users may scroll the contents of containers 505 and/or 510 to reveal additional deal icons hidden from view.

Further embodiments size deal icons 503 and 507 in proportion to their absolute or relative value or other deal attribute and/or shade, color, and/or otherwise pattern deal icons 503 and 507 to indicate additional information, such as the win probability, or probability of completing the deal; the amount of recent activity associated with the deal; the amount of time that the deal have been in progress, in total or within a specific sales stage or category; a product, service, or region category associated with a deal; a business group, division, or individual responsible for the deal; or any other attribute associated with the deal. Still a further embodiment displays a legend 525 to assist users in understanding the shading, coloring, or other patterning of deal icons 503 and 507.

In sales forecast visualization 500, the deal icons do not have any text labels visible by default. However, an additional embodiment optionally displays text labels on some or all of the deal icons 503 and 507. Text labels may include information such as the deal name, customer name, win probability, deal value, or any other attributes associated with the deal. Text labels may be omitted or abbreviated for some of the deal icons 503 and 507, such as for smaller deal icons. Additionally, a pop-up window may display deal attributes in response to user interaction with a deal icon, such as selecting or moving the deal icon, and disappear when the user interaction is complete.

An embodiment of example sales forecast visualization 500 also includes an aggregate value indicator 515 next to container 505. In example 500, aggregate value indicator 515 may be displayed as an indicator next to container 505, with the height of the indicator proportional to an aggregate value of deal attributes associated with the time period represented by the container. In still an additional embodiment, an aggregate value indicator label 520 may provide text and/or numerical labels related to the aggregate value indicator 515. For example, aggregate value indicator label 520 specifies that the total value of the deals associated with container 505 is $2.7 million and this value is short of a goal value by $4.5 million.

Container 505 also includes a time scale 530 arranged in this example 500 along the bottom of the container. In this example 500, time scale 530 shows the time period associated with container 505 in finer detail, such as individual months within the current fiscal quarter. Deal icons are approximately aligned horizontally with the time scale 530 within container 505 based on their expected closing dates or other time-based deal attribute.

Container 505 also includes a set of gradations, including gradations 535A-535D. Gradations 535A-D may be used to represent an additional deal attribute. Each gradation is associated with at least one deal attribute value. For example, deals may be categorized into sales stages, which represent the approximate progress of a deal towards deal closing. In an embodiment of sales forecast visualization 500, each gradation is associated with a different sales stage deal attribute value and the deal icons are arranged vertically within container 505 so that they are located in the gradations corresponding to their sales stages. Gradations may be associated with a single deal attribute value, or a range of deal attribute values and/or multiple non-contiguous deal attribute values.

Visualization 500 may arrange deal icons 507 in container 510 in numerous ways. For example, deal icons 507A-D in container 510 are arranged in a sorted arrangement, with the larger valued deal icons at higher levels than smaller valued deal icons. Additional, lower-valued deal icons may be positioned off-screen and accessed by vertically scrolling the contents of container 510. Additionally, as described in detail above, as deal icons are added or removed from container 510, the arrangement of deal icons is automatically updated to maintain the sorting by deal value.

In still a further embodiment, users and applications may apply filtering criteria to limit the display of deal icons and aggregate indicators in the sales forecast visualization 500 based on any attribute associated with a deal or other entity in the CRM software, including all or part of a deal or customer name; a deal value; the deal win probability; the amount of recent activity associated with the deal; a sales stage or other deal progress metric or category; the amount of time that the deal have been in progress, in total or within a specific sales stage or category; a product, service, or region category associated with a deal; and a business group, division, or individual responsible for the deal.

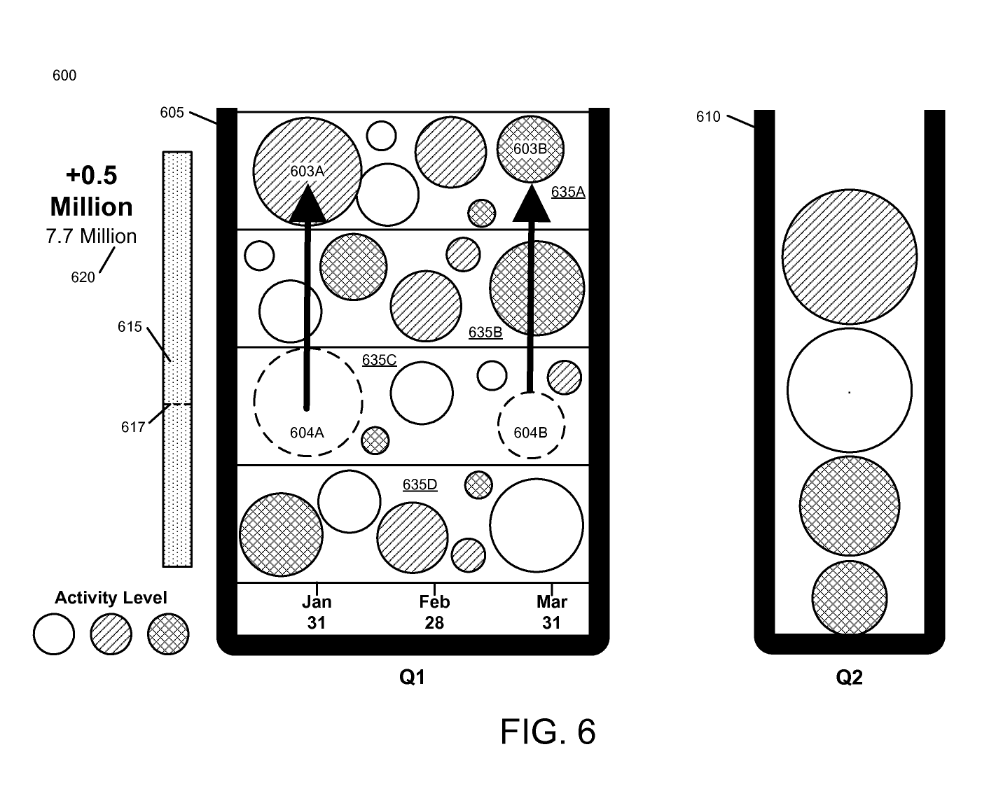

FIG. 6 illustrates a third example interaction with a sales forecast visualization 600 according to an embodiment of the invention. Sales forecast visualization 600 is similar to sales forecast visualization 500 and includes containers 605 and 610. Container 605 is partitioned into gradations 635A-635D, which in this example represent different sales stages of deals in progress. An aggregate value indicator 615 and label 620 specify the total value of deals expected to be closed or completed in the current time period.

In a third example interaction, a user moves one or more deal icons to a different gradation within container 605. For example, a user may move deal icons 603A and 603B from starting locations 604A and 604B in gradation 635C to locations in gradation 635A. This changes the sales stages of the deals associated with these deal icons and updates the aggregate value indicator 615 and label 620 accordingly. For example, the value of the aggregate value indicator 615 moves from level 617, representing the aggregate value of the deals prior to the user interaction, to the level shown in example 600.

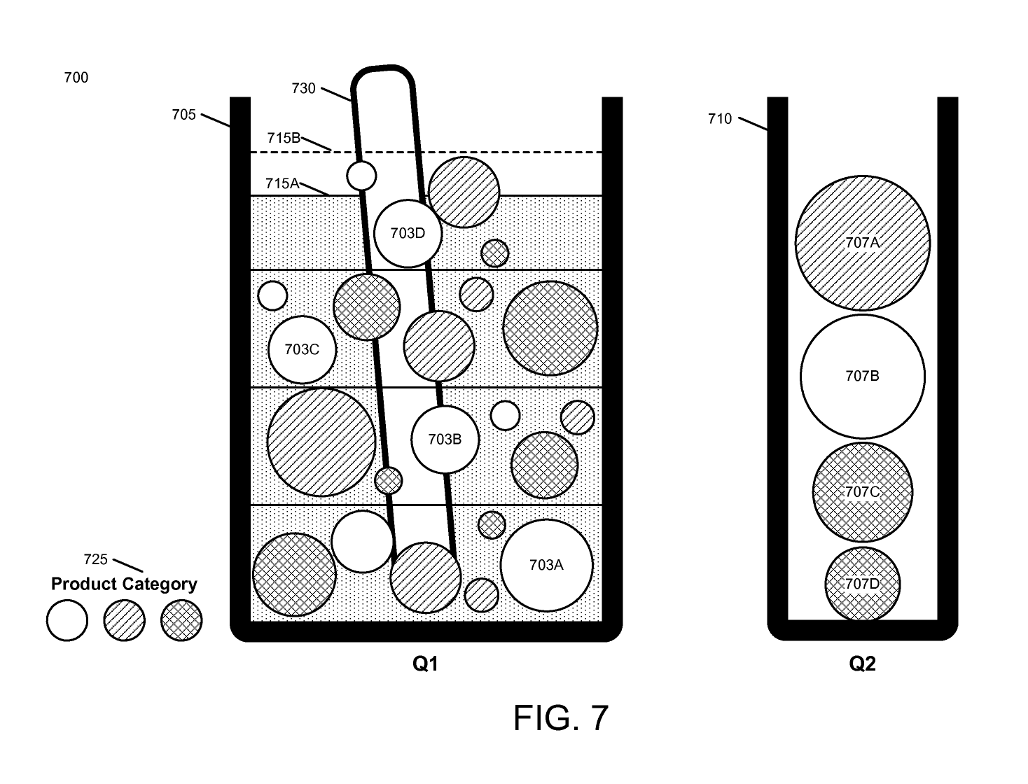

FIG. 7 illustrates an example sales forecast visualization according to yet another embodiment of the invention. Visualization 700 is similar to visualization 500 and includes at least two containers 705 and 710, representing sales information for a present time period (Q1) and a future time period (Q2), respectively. Containers 705 and 710 optionally contain deal icons, including deal icons 703A-703D in container 705 and 707A-D in container 710. Each of the containers 705 and 710 may include zero or any arbitrary number of deal icons. Additional embodiments may allow users may scroll the contents of containers 705 and/or 710 to reveal additional deal icons hidden from view.

Further embodiments size deal icons 703 and 707 in proportion to their absolute or relative value or other deal attribute and/or shade, color, and/or otherwise pattern deal icons 703 and 707 to indicate additional information, such as the win probability, or probability of completing the deal; the amount of recent activity associated with the deal; the amount of time that the deal have been in progress, in total or within a specific sales stage or category; a product, service, or region category associated with a deal; a business group, division, or individual responsible for the deal; or any other attribute associated with the deal. Still a further embodiment displays a legend 725 to assist users in understanding the shading, coloring, or other patterning of deal icons 703 and 707.

In sales forecast visualization 700, the deal icons do not have any text labels visible by default. However, an additional embodiment optionally displays text labels on some or all of the deal icons 703 and 707. Text labels may include information such as the deal name, customer name, win probability, deal value, or any other attributes associated with the deal. Text labels may be omitted or abbreviated for some of the deal icons 703 and 707, such as for smaller deal icons. Additionally, a pop-up window may display deal attributes in response to user interaction with a deal icon, such as selecting or moving the deal icon, and disappear when the user interaction is complete.

Container 705 also includes a set of gradations, including gradations 735A-735D, to represent an additional deal attribute. For example, deals may be categorized into sales stages, which represent the approximate progress of a deal towards deal closing. In an embodiment of sales forecast visualization 700, deal icons are arranged vertically within container 705 so that they are located in the gradations corresponding to their sales stages.

Visualization 700 may arrange deal icons 707 in container 710 in numerous ways. For example, deal icons 707A-D in container 710 are arranged in a sorted arrangement, with the larger valued deal icons at higher levels than smaller valued deal icons. Additional, lower-valued deal icons may be positioned off-screen and accessed by vertically scrolling the contents of container 710. Additionally, as described in detail above, as deal icons are added or removed from container 710, the arrangement of deal icons is automatically updated to maintain the sorting by deal value.

An embodiment of example sales forecast visualization 700 also includes an aggregate value indicator 730 placed within or next to container 705. In this example 700, container 705 may be visually styled as a drinking glass, the deal icons as bubbles in the liquid inside the drinking glass, and the aggregate value indicator 730 as a drinking straw. Aggregate value indicator 730 is angled according to the aggregate values of the deals in the current time period or any other aggregate deal attribute value. For example, the aggregate value indicator 730 may be angled to the left to indicate that the value of the deals in the current quarter fall short of the goal value, vertically to indicate that the values of the deals is at the goal value, and to the right to indicate that the value of the deals is above the goal value.

Additional embodiments of the invention may combine the angled indicator 730 with another aggregate value indicator, such as a liquid level indicator 715A representing the current aggregate value of the deals expected to close in the current time period, and an aggregate goal indicator 715B representing the goal value for the current time period. By visually comparing the distance between the indicators 715A and 715B, as well as the angle of indicator 730, a user can understand how the current sales forecast compares with the sales goals.

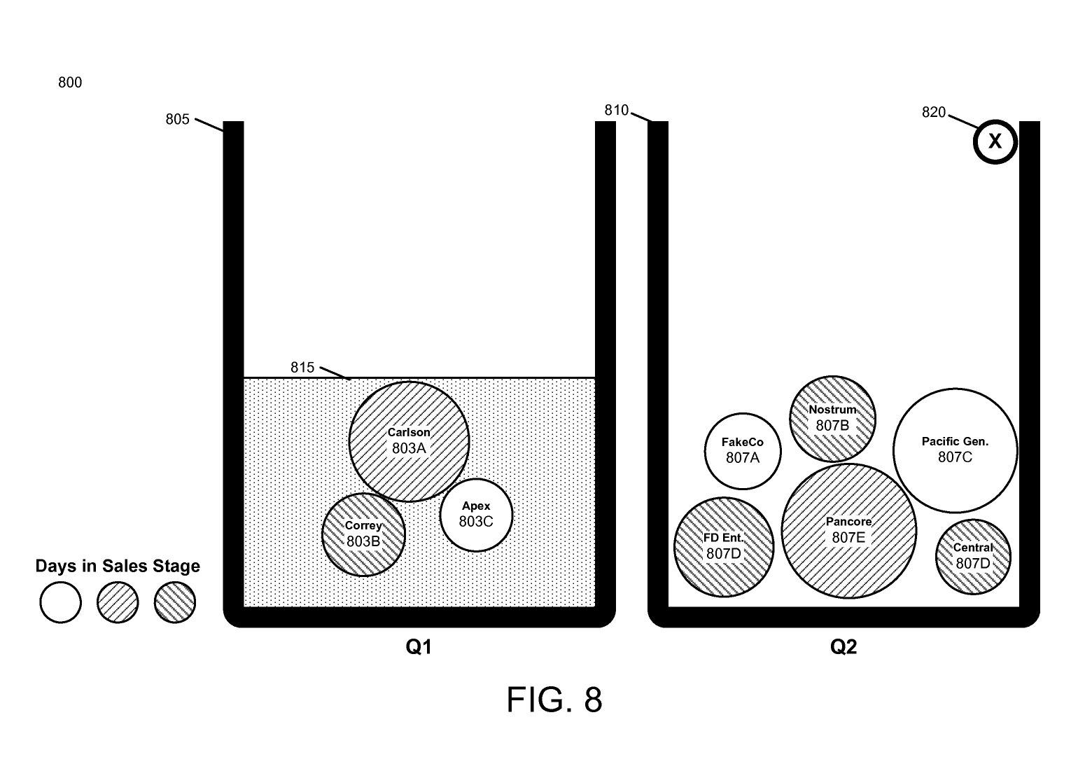

FIG. 8 illustrates a fourth example interaction with a sales forecast visualization 800 according to an embodiment of the invention. Sales forecast visualization 800 is similar to sales forecast visualization 100, including containers 805 and 810, containing deal icons 803A-C and 807A-F, respectively. Container 805 also includes an aggregate value indicator 815 representing the aggregate value of an attribute, such as the deal value, of deal icons 803A-C.

Sales forecast visualization 100 in FIG. 1 shows container 110, representing a future time period, as narrower than container 105. In an embodiment, a user interaction, such as tapping the container, selecting a user interface element, or any other type of user input, may be used to expand container 110. Visualization 800 shows the results of this user interaction, with container 110 from FIG. 1 expanded into container 810 as shown in FIG. 8.

Sales forecast visualization may rearrange the deal icons 807A-F in container 810 to fill this container in its expanded state, including adding deal icons previously off-screen when this container was in its collapsed form. Users may manipulate deal icons in containers 805 and 810 in similar manners as discussed above. Additionally, visualization 800 may include a user interface element 820 for reverting container 810 back to the narrower form shown in FIG. 1.

The expanded container in visualization 800 may be generated from containers shown in any of the visualizations discussed elsewhere in this application. Furthermore, the expanded container 810 may include its own aggregate value indicator, aggregate value label, gradations representing sales stages or other deal attributes, angular indicators, and/or time scales.

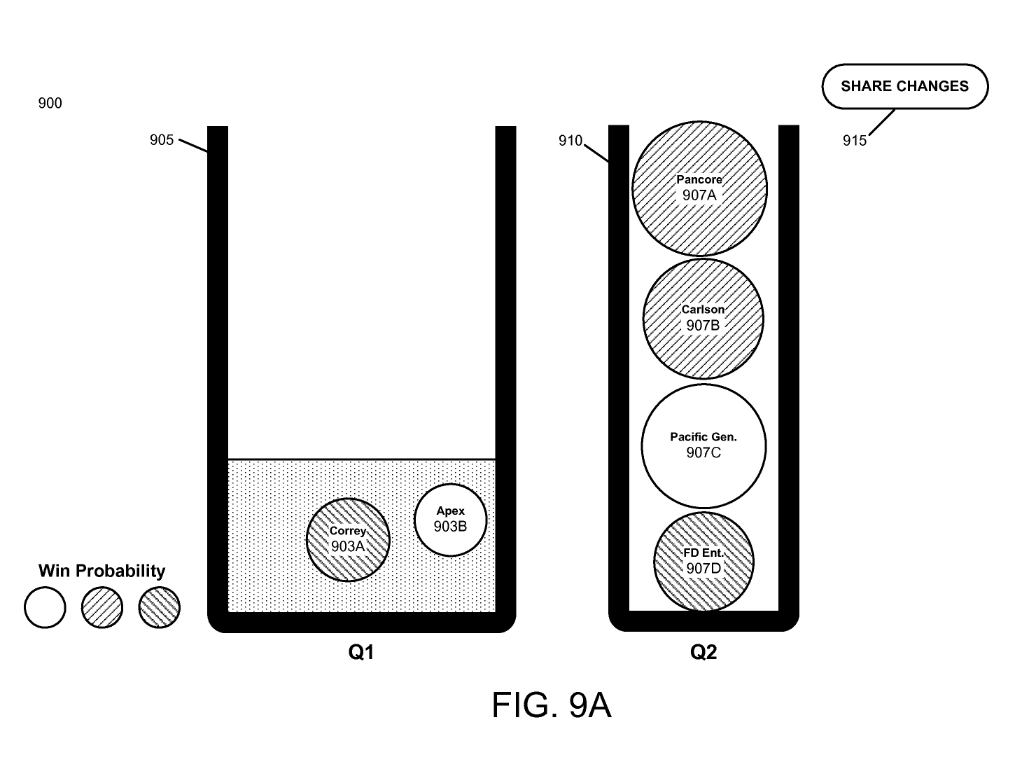

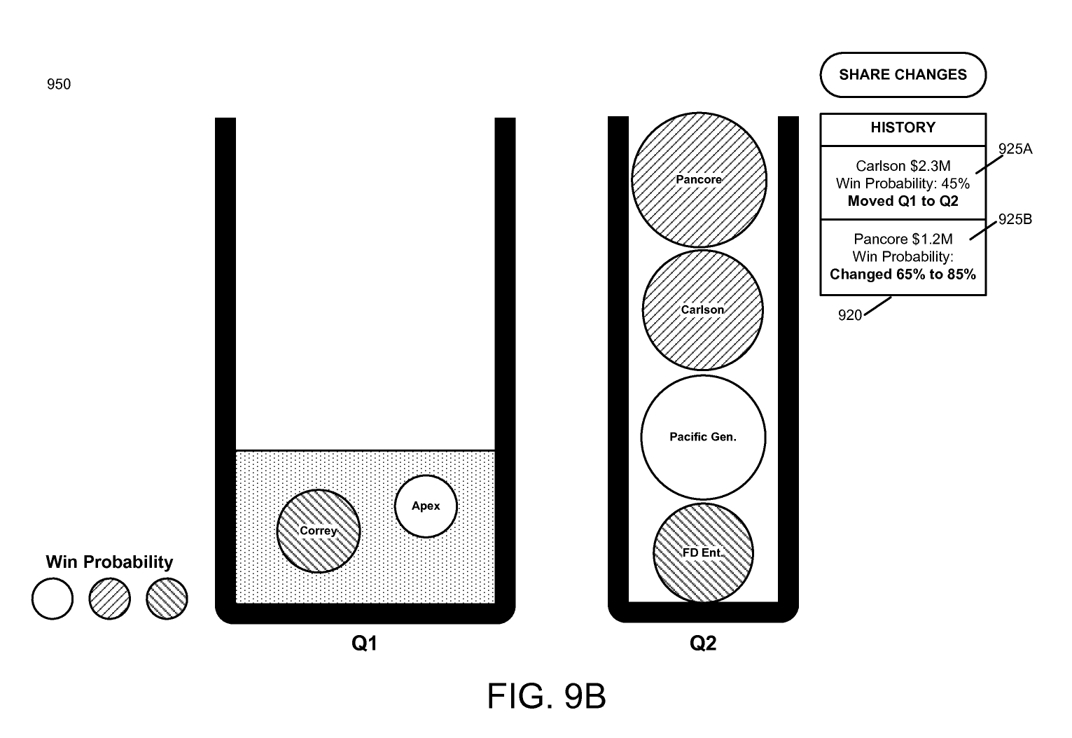

As discussed above, embodiments of the sales forecast visualization may be modified in response to user interactions to explore hypothetical changes to the sales forecast. Additionally, these hypothetical changes may be saved to update the sales forecast. A further embodiment of the invention includes a collaboration interface and functions for sharing proposed and/or implemented changes in the sales data. FIGS. 9A-9B illustrate example collaboration interfaces and functions suitable for use with embodiments of the invention.

FIG. 9A illustrates a sales forecast visualization 900 including collaboration functions according to an embodiment of the invention Like the visualizations discussed above, sales forecast visualization 900 includes containers 900 and 910 including deal icons 903A-B and 907A-D, respectively. These deal icons may be moved between containers to change the sales data and projected sales revenue.

Following any change in the sales data through the sales forecast visualization 900, an embodiment of the invention adds or enables a collaboration user interface control 915 to the visualization. The collaboration user interface control 915 enables the user to activate collaboration functions and share some or all of the changes to the sales data with one or more users. Prior to any changes in the sales data through the sales forecast visualization 900, this collaboration user interface control 915 may not be visible or disabled.

FIG. 9B illustrates a sales forecast visualization 950 following the activation of the collaboration functions, for example using the collaboration user interface control 915 shown in FIG. 9A. In an embodiment, the collaboration functions display a list or history 920 of the changes made in the sales data via the sales forecast visualization. For example, history 920 includes example change item 925A, which indicates that the Carlson deal has moved from Q1 to Q2, and example change item 925B, which indicates that the deal win probability of the Pancore deal has increased from 65% to 85%. Change items in the history 920 may include summaries of the deal information, such as the deal name, deal value, and win probability, as well as a description of the change in sales data.

A user may select one or more of these changes items for distribution to other users. Changes in sales data may be communicated via e-mail, within the CRM or other application software using the sales data, or via any other type of electronic communications. Additionally, embodiments of the invention may distribute the changes in sales data in any type of human and/or machine-readable data format, including as a image or document file showing the updated sales forecast visualization, as a table or list, or in formats such as csv, xml, tsv, or json formats.

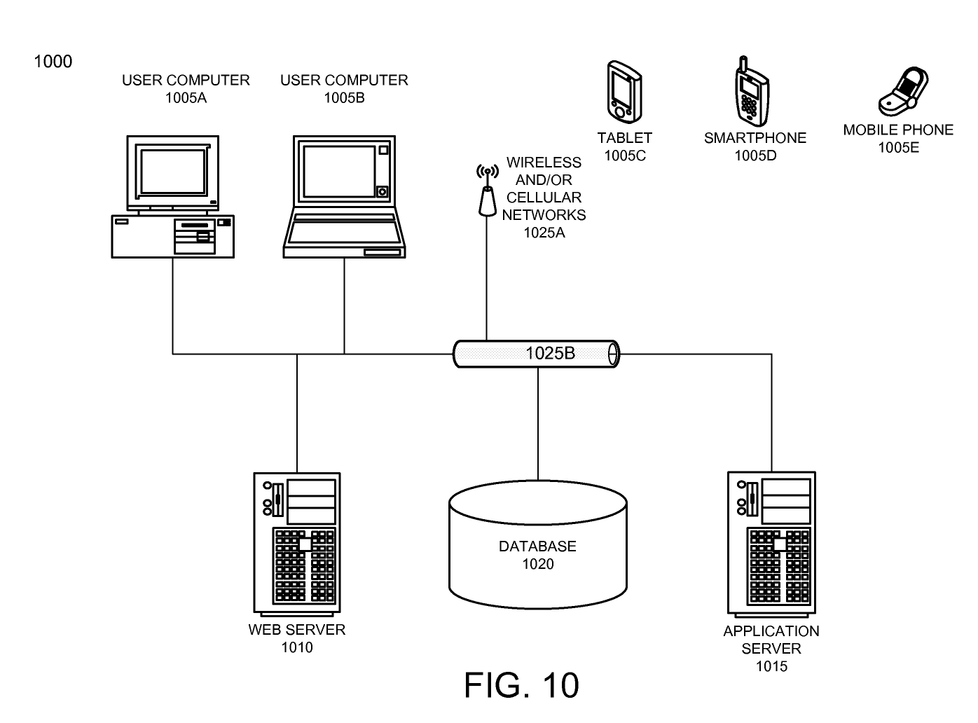

FIG. 10 illustrates an example system suitable for implementing embodiments of the invention. Embodiments of the invention may be implemented as standalone applications or as web-based applications implemented using a combination of client-side and server-side code. The system includes user computers 1005 including desktop 1005A and portable personal computers 1005B, tablets 1005C, smartphones 1005D, and mobile phones 1005E. The system can interface with any type of electronic device, such as a thin-client computer, Internet-enabled mobile telephone, mobile Internet access device, tablet, electronic book, or personal digital assistant, capable of displaying and navigating web pages or other types of electronic documents and/or executing applications. Although the system 1000 is shown with five user computers, any number of user computers can be supported.

A web server 1010 is used to process requests from web browsers and standalone applications for web pages, electronic documents, enterprise data or other content, and other data from the user computers. The server 1010 may also provide push data or syndicated content, such as RSS feeds, of data related to enterprise operations.

Application server 1015 operates one or more applications. The applications can be implemented as one or more scripts or programs written in any programming language, such as Java, C, C++, C#, or any scripting language, such as JavaScript or ECMAScript, Perl, PHP, Python, Ruby, or TCL. Data applications can be built using libraries or application frameworks, such as Rails, Enterprise JavaBeans, or .NET. Web content can created using HTML, CSS, and other web technology, including templating languages and parsers.

The data applications on application server 1015 process input data and user computer requests and can store or retrieve data from database 1020. Database 1020 stores data created and used by the data applications. In an embodiment, the database 1020 is a relational database that is adapted to store, update, and retrieve data in response to SQL format commands or other database query languages. In other embodiments, unstructured data storage architectures and NoSQL databases may also be used.

In an embodiment, the application server 1015 is one or more general-purpose computers capable of executing programs or scripts. In an embodiment, the web server 1010 is implemented as an application running on one or more general-purpose computers. The web server and application server may be combined and executed on the same computers.

An electronic communication network 1025 enables communication between user computers 1005, web server 1010, application server 1015, and database 1020. In an embodiment, network 1025 may further include any form of electrical or optical communication devices, including wireless 1025A and wired 1025B networks. Network 1025 may also incorporate one or more local-area networks, such as an Ethernet network; wide-area networks, such as the Internet and cellular carrier data networks; and virtual networks, such as a virtual private network.

The system is one example for executing applications according to an embodiment of the invention. In another embodiment, application server, web server, and optionally database can be combined into a single server computer application and system. In a further embodiment, virtualization and virtual machine applications may be used to implement one or more of the application server, web server, and database. In still further embodiments, all or a portion of the web server and application functions may be integrated into an application running on each of the user computers. For example, a JavaScript application on the user computer may be used to retrieve or analyze data and display portions of the applications.

Although the description has been described with respect to particular embodiments thereof, these particular embodiments are merely illustrative, and not restrictive. Any suitable programming language can be used to implement the routines of particular embodiments. Any type of programming techniques may be employed including procedural, functional, and/or object oriented programming techniques. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a tangible computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A data visualization comprising:
a first container representing a first time period and including an interior region, wherein the interior region is adapted to at least partially enclose icons representing data entities associated with the first time period;
a level indicator representing an aggregate value of the data entities associated with the first time period;
wherein the level indicator is adapted to change in response to a first icon being added to or removed from the interior region of the first container in accordance with the size of the first icon.

2. The data visualization of claim 1, wherein the level indicator is adapted to change in proportionally with the size of the first icon.

3. The data visualization of claim 1, wherein the size of first icon is proportional to an attribute value of a first data entity represented by the first icon.

4. The data visualization of claim 3, wherein the first data entity is a business deal and the attribute value is a deal value.

5. The data visualization of claim 1, wherein the first container is visually styled as a cup.

6. The data visualization of claim 5, wherein the level indicator is visually styled as a liquid contained in the cup.

7. The data visualization of claim 5, wherein the level indicator is visually styled as a straw inserted in the cup, wherein the straw is oriented at an angle based on the aggregate value of the data entities associated with the first time period.

8. The data visualization of claim 1, comprising:
a second container representing a second time period and including a second interior region, wherein the second interior region of the second container is adapted to at least partially enclose additional icons representing second data entities associated with the second time period.

9. The data visualization of claim 8, comprising:
wherein the first icon is adapted to be moveable from the first container to the second container to associate a first one of the data entities corresponding with the first icon with the second time period; and
wherein the second container includes a second icon, and the second icon is adapted to be moveable from the second container to the first container to associate a first one of the second data entities corresponding with the second icon with the first time period.

10. The data visualization of claim 1, wherein the icons at least partially enclosed by the first container correspond with a subset of the data entities associated with the first time period and satisfying a filter criteria.

11. The data visualization of claim 1, wherein the level indicator includes a threshold marker indicating a desired aggregate value of the data entities associated with the first time period.

12. The data visualization of claim 1, wherein the interior region is partitioned into at least two gradations, wherein each gradation is associated with at least one attribute value and is adapted to at least partially enclose a portion of the icons representing data entities associated with the first time period and matching the gradation associated attribute value.

13. The data visualization of claim 1, wherein the interior region is partitioned by a time scale, such that each of the icons in the interior region is at least approximately aligned with the time scale based on an attribute value of its corresponding data entity.

14. The data visualization of claim 1, further adapted to update an association of a first data entity, corresponding with the first icon, with the first time period in response to the first icon being added to or removed from the interior region of the first container.

15. The data visualization of claim 14, comprising a collaboration interface adapted to share changes to the first data entity with at least one user.

16. A method for manipulating a data visualization in a computing system, the method comprising:
retrieving data entities associated with at least first and second time periods;
generating for display first and second containers, wherein the first and second containers are associated with the first and the second time periods, respectively;
generating first icons for display in the first container, wherein the first icons correspond with a first portion of the data entities associated with the first time period;
generating second icons for display in the second container, wherein the second icons correspond with a second portion of the data entities associated with the second time period;
generating for display a level indicator representing an aggregate attribute value of the first portion of the data entities;
receiving a user interaction moving at least one of the first or second icons from its associated container to the other container; and
in response to the user interaction, changing the level indicator in accordance with an attribute value of one of the data entities corresponding with the moved icon.

17. The method of claim 16, wherein at least some of the first and second icons are sized according attribute values of the corresponding data entities.

18. The method of claim 16, wherein in response to the user interaction, changing the time period associated with the one of the data entities corresponding with the moved icon to the time period associated with the other container.

19. The method of claim 16, wherein the first container and second containers are visually styled as cups and the level indicator is visually styled as a liquid contained in one of the cups.

20. A tangible, computer-readable data storage medium including instructions adapted to direct a processor to perform an operation, the operation comprising:
retrieving data entities associated with at least first and second time periods;
generating for display first and second containers, wherein the first and second containers are associated with the first and the second time periods, respectively;
generating first icons for display in the first container, wherein the first icons correspond with a first portion of the data entities associated with the first time period;
generating second icons for display in the second container, wherein the second icons correspond with a second portion of the data entities associated with the second time period;
generating for display a level indicator representing an aggregate attribute value of the first portion of the data entities;
receiving a user interaction moving at least one of the first or second icons from its associated container to the other container; and
in response to the user interaction, changing the level indicator in accordance with an attribute value of one of the data entities corresponding with the moved icon.

21. A tangible, computer-readable data storage medium including instructions adapted to direct a processor to perform an operation, the operation comprising:
retrieving data entities associated with at least a first time period from a data storage;
for each of the data entities associated with the first time period, retrieving at least one attribute value from the data storage;
summing the retrieved attributes values to determine an aggregate attribute value for the first time period;
determining a level indicator size based on the aggregate attribute value;
determining an icon size for each of the data entities based on their respective retrieved attribute values;
generating for display a first container;
generating icons for display in the first container, wherein the first icons correspond with at least a portion of the data entities and have their respective data entities selected icon sizes; and
generating for display a level indicator associated with the first container and having the level indicator size.
